(19) United States
(12) Patent Application Publication
(10) Pub. No.: US 2020/0181029 A1
(43) Pub. Date: Jun. 11, 2020

(54) A METHOD OF FABRICATING A PART OUT OF CERAMIC MATRIX COMPOSITE MATERIAL

(71) Applicant: SAFRAN CERAMICS, LE HAILLAN (FR)

(72) Inventors: Aurélia CLERAMBOURG, ST JEAN D'ILLAC (FR); Marie LEFEBVRE, BORDEAUX (FR); Sébastien DENNEULIN, BORDEAUX (FR); Eric PHILIPPE, PARIS (FR); Eric BOUILLON, LE HAILLAN (FR)

(21) Appl. No.: 16/312,545

(22) PCT Filed: Jun. 28, 2017
(86) PCT No.: PCT/FR2017/051733

§ 371 Date: Dec. 21, 2018

(30) Foreign Application Priority Data
Jun. 29, 2016 (FR) 1656093

(51) Int. Cl. C04B 35/80; C04B 35/628; C04B 35/657; D03D 25/00

(52) U.S. Cl. CPC C04B 35/806; C04B 35/62863; C04B 35/62873; C04B 35/657; D03D 25/005; D10B 2505/02; C04B 2235/422; C04B 2235/5436; C04B 2235/5244; C04B 2235/5256; D10B 2101/08; C04B 2235/3826

(57) ABSTRACT

A method of fabricating a composite material part including fiber reinforcement and a ceramic matrix present in the pores of the fiber reinforcement, the method including a) forming the fiber reinforcement by three-dimensionally weaving ceramic yarns, the fiber reinforcement as formed in this way presenting an interlock weave; b) forming a first ceramic matrix phase in the pores of the fiber reinforcement; c) after performing step b), introducing into the pores of the fiber reinforcement a powder that includes a mixture of SiC particles and of carbon particles; and d) infiltrating the fiber reinforcement obtained after performing step c), with an infiltration composition in the molten state including at least silicon so as to form a second ceramic matrix phase in the pores of the fiber reinforcement, thereby obtaining the composite material part.

### BACKGROUND OF THE INVENTION

The present invention relates to the general field of methods of fabricating parts out of ceramic matrix composite material.

There are various known methods for fabricating parts out of ceramic matrix composite (CMC) material. One of them is filling fiber reinforcement with a matrix by chemical vapor infiltration (CVI). CVI serves to obtain parts that present good mechanical properties associated with high filling densities, nevertheless, that method presents the drawback of being expensive.

Another known method is referred to as “pre-preg”, in which yarns that have been preimpregnated with carbon precursor resin are shaped into sheets that are subsequently draped in order to obtain a fiber preform. The fiber preform is molded, heated, and finally infiltrated with a silicon alloy in the liquid state (a technique known as “melt-infiltration” (MI)). Nevertheless, it can be relatively difficult to use that method to make a part that is of complex three-dimensional shape.

It should also be observed that parts obtained by the MI technique can present significant residual porosity, due in particular to the non-uniform penetration of the molten metal into the fiber reinforcement. The mechanical properties of parts obtained by that method can therefore be improved.

There therefore exists a need to have a method of fabrication that costs relatively little to perform and that makes it possible to obtain a CMC part that is complex in shape with improved mechanical properties and a low residual porosity.

### OBJECT AND SUMMARY OF THE INVENTION

A main object of the present invention is thus to mitigate such drawbacks by proposing a method of fabricating a composite material part comprising fiber reinforcement and a ceramic matrix present in the pores of the fiber reinforcement, the method comprising at least the following steps:

a) forming the fiber reinforcement by three-dimensionally weaving ceramic yarns, the fiber reinforcement as formed in this way presenting an interlock weave;

b) forming a first ceramic matrix phase in the pores of the fiber reinforcement;

c) after performing step b), introducing into the pores of the fiber reinforcement a powder that comprises ceramic particles and/or carbon particles; and

d) after performing step c), infiltrating the fiber reinforcement with an infiltration composition in the molten state comprising at least silicon so as to form a second ceramic matrix phase in the pores of the fiber reinforcement, thereby obtaining the composite material part.

Using fiber reinforcement having an interlock weave enables the powder particles to penetrate better into the pores of the reinforcement during step c). Specifically, the inventors have found that, after step b), the interlock weave defines pore channels that are adapted to enabling particles to penetrate better into the thickness of the reinforcement. As a result, the infiltration composition in the molten state also penetrates more easily into the fiber reinforcement during step d), thereby wetting the ceramic and/or carbon particles already present in the pores of the fiber reinforcement. In an implementation, the porosity in the part that is obtained after performing in step d) may be less than equal to 5%, or indeed less than or equal to 3%. Thus, the mechanical properties of the CMC material part that is obtained are improved and its residual porosity is reduced. In addition, the use of three-dimensional weaving for making the fiber reinforcement makes it possible to obtain parts that are of complex shape.

In an implementation, particles of SiC, of Si₃N₄, of BN, of SiB₆, of B₄C, or a mixture of such particles may be introduced during step c).

In an implementation, particles of SiC may be introduced during step c).

A mixture of particles of SiC and particles of carbon is introduced during step c).

In an implementation, the mean size of the particles introduced during step c) may be less than or equal to 5 μm, or indeed less than or equal to 1 μm. The term “mean size of the particles” should be understood as the D₅₀ size of the particles.

In an implementation, the first ceramic matrix phase may comprise silicon carbide (SiC).

In an implementation, after performing step b), the residual porosity by volume in the fiber reinforcement (=pore volume divided by fiber reinforcement volume), lies in the range 30% to 35%.

In an implementation, an interphase may be formed on the ceramic yarns prior to step b).

In an implementation, the fiber reinforcement comprises silicon carbide yarns may present an oxygen content less than or equal to 1 atomic percent.

Finally, the invention provides the above-described method in which the fabricated part is a turbine engine part. The part may be a part for the hot portion of a gas turbine in an aeroengine or in an industrial turbine. In particular, the part may constitute at least a portion of a guide vane nozzle, a wall of a combustion chamber, a turbine ring sector, or a turbine engine blade.

### BRIEF DESCRIPTION OF THE DRAWINGS

Other characteristics and advantages of the present invention appear from the following description made with reference to the accompanying drawings, which are provided by way of non-limiting example. In the figures:

FIG. 1 is a flow chart showing the various steps of an example method of the invention;

FIG. 2 is a diagram showing an example interlock weave;

FIG. 3 is a photograph showing a section of a part obtained by a method of the invention; and

FIG. 4 is a photograph showing a section of a part obtained by a method not in accordance with the invention.

### DETAILED DESCRIPTION OF THE INVENTION

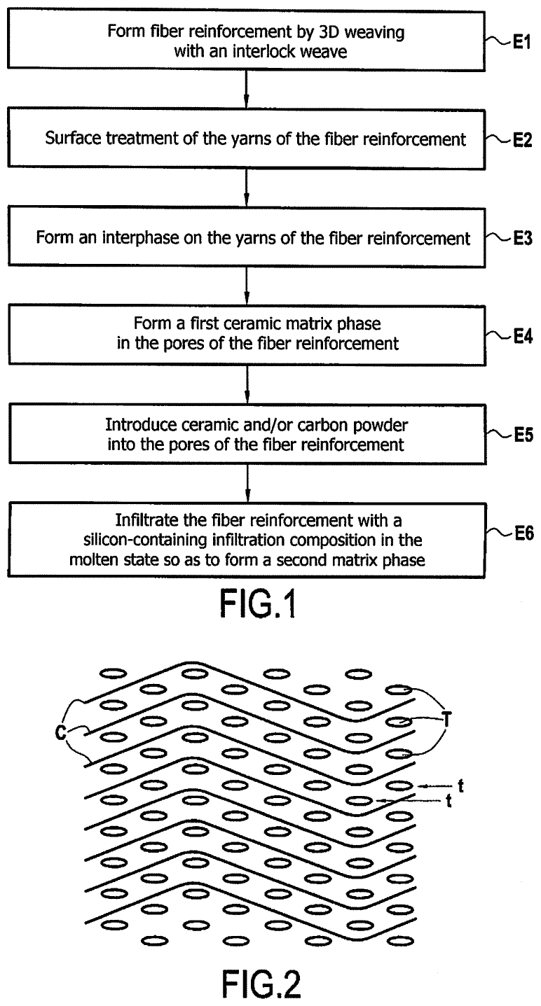

An example of a method of fabricating a CMC material part in accordance with the invention is described below with reference to the flow chart of FIG. 1.

A first step E1 of the method (step a)) may consist in forming the fiber reinforcement for the part by three-dimensional weaving in order to obtain fiber reinforcement presenting an interlock weave. The fiber reinforcement may be made out of ceramic yarns, e.g. silicon carbide yarns. The fiber reinforcement obtained during step E1 constitutes a fiber preform for the part that is to be fabricated.

Examples of suitable silicon carbide yarns may be “Nicalon”, “Hi-Nicalon”, or “Hi-Nicalon S” yarns as sold by the Japanese supplier NGS. The ceramic yarns of the fiber reinforcement may present an oxygen content that is less than or equal to 1 atomic percent (1 at %). “Hi-Nicalon S” yarns present this characteristic.

The term “three-dimensional weaving” or “3D weaving” should be understood as a weaving technique in which at least some of the warp yarns link together weft yarns over a plurality of weft layers. In the invention, the fiber reinforcement presents an interlock weave. The term “interlock weave or fabric” should be understood as a 3D weave in which each layer of warp yarns C links together a plurality of layers of weft yarns T, with all of the yarns C of a given warp column having the same movement in the weave plane. In the example shown in FIG. 2, the weft layer is formed by two adjacent weft half-layers t that are offset from each other in the warp direction. Thus, in this example there are 18 weft half-layers arranged in a staggered configuration. Each warp yarn C links together three weft half-layers t. Nevertheless, it is possible to adopt a weft configuration that is not staggered, the weft yarns of two adjacent weft layers being aligned in the same column. In the present specification, interchanging the roles of warp and weft yarns should be considered as being covered likewise by the claims.

A step E2 of treating the surfaces of the ceramic yarns is preferably performed prior to forming an interphase, in particular in order to eliminate the sizing that may be present on the fibers.

In a step E3, an embrittlement-relief interphase may be formed on the ceramic yarns of the fiber reinforcement by CVI. By way of example, the interphase may present thickness lying in the range 10 nanometers (nm) to 1000 nm, e.g. lying in the range 10 nm to 100 nm. After the interphase has been formed, the fiber reinforcement remains porous, since the interphase fills only a minority fraction of the initially accessible porosity.

The interphase may comprise a single layer or multiple layers. The interphase may include at least one layer of pyrolytic carbon (PyC), of boron nitride (BN), of silicon-doped boron nitride (BN(Si), with silicon present at a weight percentage lying in the range 5% to 40%, the balance being boron nitride), or boron-doped carbon (BC, with boron at an atomic percentage lying in the range 5% to 20%, the balance being carbon). In this example, the function of the interphase is to provide the composite material with embrittlement relief serving to enhance deflection of any cracks that might reach the interphase after propagating through the matrix, thereby preventing or retarding rupture of fibers by such cracks. In a variant, it should be observed that it is possible to form the interphase on the ceramic fibers prior to weaving the fiber reinforcement, i.e. prior to performing step E1 (step a)).

Thereafter, a step E4 is performed of forming a first ceramic matrix phase in the pores of the fiber reinforcement (step b)), on the interphase that has previously have been performed, if any, or else directly on the yarns of the fiber reinforcement. This matrix phase may be formed by CVI. By way of example, the first ceramic matrix phase may comprise SiC. The residual porosity of the fiber reinforcement after this step E4 and prior to introducing powder may be greater than or equal to 30%, e.g. lying in the range 30% to 35%. In general manner, the residual porosity of the fiber reinforcement after performing step E4 (step b)) is sufficient to enable powder to be introduced into the pores of the fiber reinforcement and to enable a second matrix phase to be formed.

Thereafter, during the step E5, a powder comprising particles of ceramic material and/or particles of carbon is introduced into the residual pores of the fiber reinforcement (step c)). For this purpose, the fiber reinforcement may be impregnated with a composition, e.g. in the form of a slurry, that is introduced into the pores of the fiber reinforcement by methods that themselves known, e.g. by injection. Said composition may comprise the powder in suspension in a liquid medium. The ceramic particles may be particles of SiC, of Si₃N₄, of BN, of SiB₆, of B₄C, or a mixture of such particles. The D₅₀ size of the particles of the powder may be less than or equal to 5 micrometers (μm), or indeed less than or equal to 1 μm. Once the powder has been introduced into the fiber reinforcement, e.g. by injecting a slurry, the fiber reinforcement may be dried.

Thereafter, in step E6, the fiber reinforcement containing the powder as introduced in step E5 is infiltrated with an infiltration composition in the molten state (step d)), which composition comprises at least silicon, in order to form a second ceramic matrix phase in the pores of the fiber reinforcement and thereby finish off densification in order to obtain the part. This infiltration step corresponds to a melt infiltration (MI) step. The infiltration composition may be constituted by pure molten silicon, or in a variant it may be in the form of a molten alloy of silicon together with one or more other ingredients. The infiltration composition may comprise a majority of silicon by weight, i.e. it may present a weight content of silicon that is greater than or equal to 50%. By way of example, the infiltration composition may present a weight content of silicon that is greater than or equal to 75%. The other ingredient(s) present within the silicon alloy may be selected from B, Al, Mo, Ti, and mixtures thereof. When the particles of the powder introduced in step E5 are particles of C, of B₄C, or of a mixture of these particles, a chemical reaction may take place between the infiltration composition and the powder particles during the infiltration, thereby leading to silicon carbide being formed.

At the end of step E6, the CMC material part is obtained. Such a CMC material part may be a stator or rotor part of a turbine engine. Examples of turbine engine parts are mentioned above. Such a part may also be coated in an environmental/thermal barrier coating.

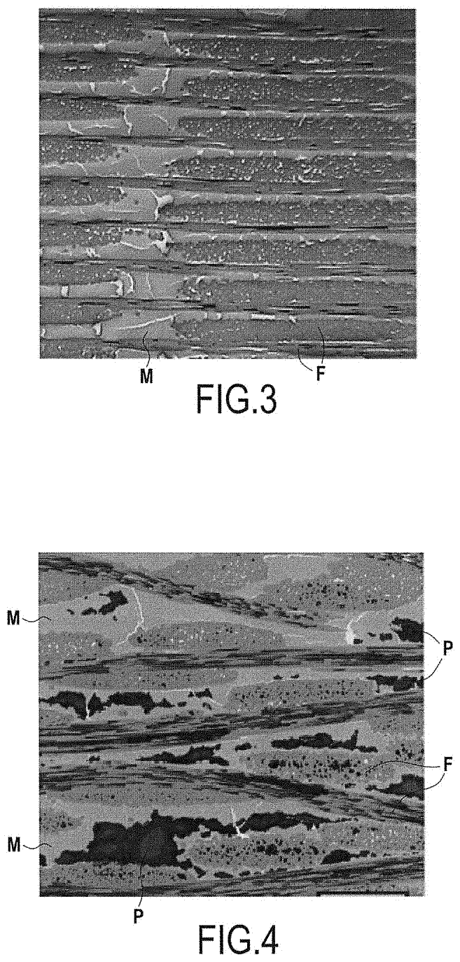

FIG. 3 shows a photograph in section of a CMC material part obtained by an example method of the invention. In this test, the fiber reinforcement presents an interlock weave and it was pre-densified by CVI (step E4) in order to obtain a first matrix phase of SiC. After that pre-densification, the fiber reinforcement presented residual porosity by volume lying in the range 30% to 35%. During step E5, an SiC powder (sold by Marion Technologies under the reference SiC MT59) presenting a D₅₀ mean particle size of 0.8 μm was introduced into the pores of the pre-densified fiber reinforcement. Finally, infiltration (step E6) was performed using pure silicon (sold by HC Starck under the reference Si Grade AX-20). The photograph of FIG. 3 shows the matrix M and the yarns F in the CMC matrix part as obtained in that way. With the method of the invention, the overall porosity as measured in the part is less than 1%.

By way of comparison, a test was carried out that was similar to that described above, except that the weave was a multi-satin weave instead of an interlock weave. FIG. 4 is a photograph showing a section of the CMC material part obtained during that test. Pores P of black color can be seen in the photograph of FIG. 4. Overall porosity of greater than 15% was measured in the part, and it can be seen in FIG. 4 that the pores are present both between the yarns F and within the yarns F. It can thus be seen that it is more difficult to fill in the pores in the fiber reinforcement when it presents a weave that is not an interlock weave. The mechanical properties are therefore less good in this part than in the part obtained in the preceding test making use of fiber reinforcement having an interlock weave.

1. A method of fabricating a composite material part comprising fiber reinforcement and a ceramic matrix present in pores of the fiber reinforcement, the method comprising:
a) forming the fiber reinforcement by three-dimensionally weaving ceramic yarns, the fiber reinforcement as formed in this way presenting an interlock weave;
b) forming a first ceramic matrix phase in the pores of the fiber reinforcement;
c) after performing step b), introducing into the pores of the fiber reinforcement a powder that comprises a mixture of SiC particles and of carbon particles; and
d) after performing step c), infiltrating the fiber reinforcement with an infiltration composition in the molten state comprising at least silicon so as to form a second ceramic matrix phase in the pores of the fiber reinforcement, thereby obtaining the composite material part.

2. A method according to claim 1, wherein the first ceramic matrix phase comprises silicon carbide.

3. A method according to claim 1, wherein a mean size of the particles introduced during step c) is less than or equal to 5 μm.

4. A method according to claim 1, wherein, after performing step b), a residual porosity by volume in the fiber reinforcement lies in the range 30% to 35%.

5. A method according to claim 1, wherein an interphase is formed on the ceramic yarns prior to step b).

6. A method according to claim 1, wherein the fiber reinforcement comprises silicon carbide yarns presenting an oxygen content less than or equal to 1 atomic percent.

7. A method according to claim 1, wherein the fabricated part is a turbine engine part.

8. A method according to claim 3, wherein the mean size of the particles introduced during step c) is less than or equal to 1 μm.
